(19) United States
(12) Patent Application Publication
(10) Pub. No.: US 2016/0198683 A1
(43) Pub. Date: Jul. 14, 2016

(54) Dog Droppings Catcher

(71) Applicants: Tien Szu Tseng, Taichung City (TW); Chin Fa Chang, Changhua County (TW)

(72) Inventors: Tien Szu Tseng, Taichung City (TW); Chin Fa Chang, Changhua County (TW)

(21) Appl. No.: 14/975,838

(22) Filed: Dec. 20, 2015

(30) Foreign Application Priority Data
Jan. 14, 2015 (TW) 104200547
Oct. 5, 2015 (TW) 104215916

(51) Int. Cl. A01K 23/00

(52) U.S. Cl. CPC A01K 23/005

(57) ABSTRACT

A dog droppings catcher includes a fixing board and a droppings bag. The fixing board has an end forming a coupling section and an opposite end forming an opening closure section. The droppings bag has an opening and an interior receiving space and is combinable with the coupling section. The coupling section includes a through hole in communication with the opening of the droppings bag. The device can be easily carried by a user or temporarily hung on a leash of a dog. Before dog droppings fall onto the ground, the user may hold the opening closure section in such a way as to allow the dog dropping to pass through the through hole of the coupling section into the droppings bag. The opening closure section is then folded toward the coupling section to get laid flat on the coupling section for closing the through hole of the coupling section.

### TECHNICAL FIELD OF THE INVENTION

The present invention relates generally to a dog droppings catcher, and more particularly to a handheld, disposable dog droppings cleaning device that may timely catch and hold dog droppings before the droppings fall onto the ground to prevent contamination of the ground and that allows for sealing of an opening for disposal in a garbage tank to prevent spreading of odor smell of the droppings so that the handling of dog dropping is made easy and convenient.

### DESCRIPTION OF THE PRIOR ART

The population of dog lovers and breeders is increasingly expanded and dog droppings are commonly left on streets and public places, causing severe influence of the appearance of the cities. Such a problem is getting worse day by day and is now a focused issue for the government agents. To help the dog owners to pick up dog droppings, various products are available in the market for picking up dog droppings. For example, plastic bags are often provided for picking up dog droppings and a dog owner may fit a plastic bag over one hand so that the dog owner may use the hand over which the plastic bag is fit to pick up the dog droppings with the dog droppings being separated from the hand by the plastic bag. However, the dog droppings are generally soft and warm and holding the soft and warm droppings in the hand is disgusting. In certain situations, the dog droppings may not be solid enough to pick up by hands and thus contamination of the ground may result. Taiwan Utility Model Application No. 097207859 discloses a droppings pickup device, which is a device that is specifically provided for picking up dog droppings. However, such a known device can only pick droppings that have fallen on the ground. Such a device, although helping overcome the disgusting feeling of using a hand to hold and pick up droppings, still suffers the same drawbacks of incapability of picking up droppings not in a solid form and at least partly contaminating the ground for the droppings can only be picked up after falling onto the ground. In addition, the dog owner, when walking out with his or her dog, must carry the droppings pick up device and this is definitely inconvenient.

For example, Taiwan Utility Model Application No. 099209254 discloses a pet droppings pickup device, which is also a device provided for picking up dog dropping for dog raised in urban areas. This device is advantages over the previously discussed device in that dog droppings are received in air before they fall onto the ground. This helps overcome the drawback of the previously discussed device that droppings may be partly left on the ground after being picked up. However, this device is bulky and is not a disposable product so that after picking up dog droppings, the dog owner must continuously carry the device. This is also inconvenient.

Thus, it is desired to have a dog dropping handling product that is easy to carry, prevents dog droppings from contact and contaminating the ground, and is disposable for one time use, and also allows for easy sealing of an opening to prevent undesired spreading of the odor smell of dog droppings.

### SUMMARY OF THE INVENTION

The primary object of the present invention is to provide a dog droppings cleaning device that is compact and light-weight, is easy to carry, and is disposable and that allows for receiving and holding dog droppings before the droppings fall onto the ground so as to prevent the ground from being contaminated and that allows for sealing of an opening thereof before disposed into a garbage bin so as to reduce odor smell spreading therefrom, so that cleaning and handling of dog droppings is made easy and convenient without causing staining and contamination of the ground.

A secondary object of the present invention is to allow a dog owner, when walking a dog, not to long hold the present invention before the dog discharge droppings so that at least one hand is free for doing other thing, where the present invention is hung on a ring of a leash of the dog and also allows the present invention to be readily accessed and positioned to receive dog dropping by means of an arrangement of an expandable and deformable slit opening that allows the present invention to be removed through application of a small force thereto.

Another object of the present invention is to allow the dog owner not to long hold the bag that receives and holds dog droppings therein after the dog discharges the droppings when the dog owner is walking with the dog, wherein the present invention provides an arrangement of a hanging lug that allows the present invention with dog droppings received and held therein to be hung on a ring of a leash of the dog, freeing one hand of the dog owner to do other things so that the owner does not need to use one hand hold the dog and the other hand holds the bag that receives and holds dog droppings therein.

To achieve the above objects, the present invention provides an improvement that comprises a fixing board and a droppings bag. The fixing board has an end forming a coupling section and an opposite end forming an opening closure section. The droppings bag comprises an opening and an interior in which a receiving space is defined and in communication with the opening. The droppings bag is combinable with the coupling section. The coupling section comprises a through hole in communication with the opening of the droppings bag. The opening closure section is foldable to lie flat on the coupling section for covering and closing the through hole of the coupling section. The fixing board is provided a suspension lug and the suspension lug is set at a location close to an outer contour of the fixing board. The suspension lug comprises a through hole and a slit opening extending from an edge of the through hole to the outer contour. Before acted upon by an external force, two opposite portions of the slit opening maintain in tight engagement with each other and when acted upon by an external force, the slit opening is expanded and deformed. The coupling section and the opening closure section of the fixing board form, in a connection therebetween, a folding section. The folding section comprises a hanging lug. The hanging lug is formed of a curved slit opening and a through hole formed in an area partly enclosed by the curved slit opening The curved slit opening is arranged to extend toward the opening closure section.

The present invention provides a dog droppings catcher, which has a compact and light weight arrangement, allowing a dog owner to easily carry, such as holding in a hand or inserted into a clothing pocket or a bag or temporarily hung on a ring of a leash of a dog for easy and efficient access and use so that before dog droppings discharged from a dog fall onto the ground, the owner may use a hand to hold the opening closure section of the fixing board in such a way as to allow the dog dropping to fall and pass through the through hole of the coupling section to get into the droppings bag thereby preventing the dog droppings from falling onto and staining the ground. After the dog completely discharges the droppings, the opening closure section is folded toward the coupling section to be laid flat on the coupling section so as to cover and close the through hole of the coupling section for subsequent disposal into a garbage bin for reducing odor smell spread from the dog droppings. In case no garbage bin is immediately available for disposal, the hanging lug of the fixing board may be used for hanging on the ring of the leash of the dog so that the dog owner does not need to hold the dog with one hand and hold the dog droppings with another hand. With such an arrangement, cleaning and handling dog droppings is made easy without causing staining of the ground and improved convenience can be offered to the dog owner.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a first embodiment of the present invention.

FIG. 2 is an assembled view of FIG. 1.

FIG. 3 is a schematic view illustrating a dropping bag laid flat on a fixing board and temporarily clamped in accordance with the first embodiment of the present invention.

FIG. 4 is a schematic view illustrating a slit opening of a hanging lug acted upon by a force and getting expanded and deformed in accordance with the first embodiment of the present invention.

FIG. 5 is a schematic view illustrating a suspension lug of the fixing board according to the first embodiment of the present invention suspending on a ring of a leash.

FIG. 6 is a schematic view illustrating receipt of dog dropping in accordance with the first embodiment of the present invention.

FIGS. 7-10 are schematic views illustrating an operation of closing an opening after dog droppings have been received in accordance with the first embodiment of the present invention.

FIG. 11 is a schematic view illustrating the first embodiment of the present invention, after having received dog droppings thereof and having been closed, is temporarily suspended a ring of a leash.

FIG. 12 is an exploded view showing a second embodiment of the present invention.

FIG. 13 is an exploded view showing a third embodiment of the present invention.

FIG. 14 is an exploded view showing a fourth embodiment of the present invention.

FIG. 15 is an assembled view of FIG. 14.

FIG. 16 is an exploded view showing a fifth embodiment of the present invention.

FIG. 17 is an assembled view of FIG. 16.

FIGS. 18-20 are schematic views illustrating an operation of closing an opening after dog droppings have been received in accordance with the fifth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

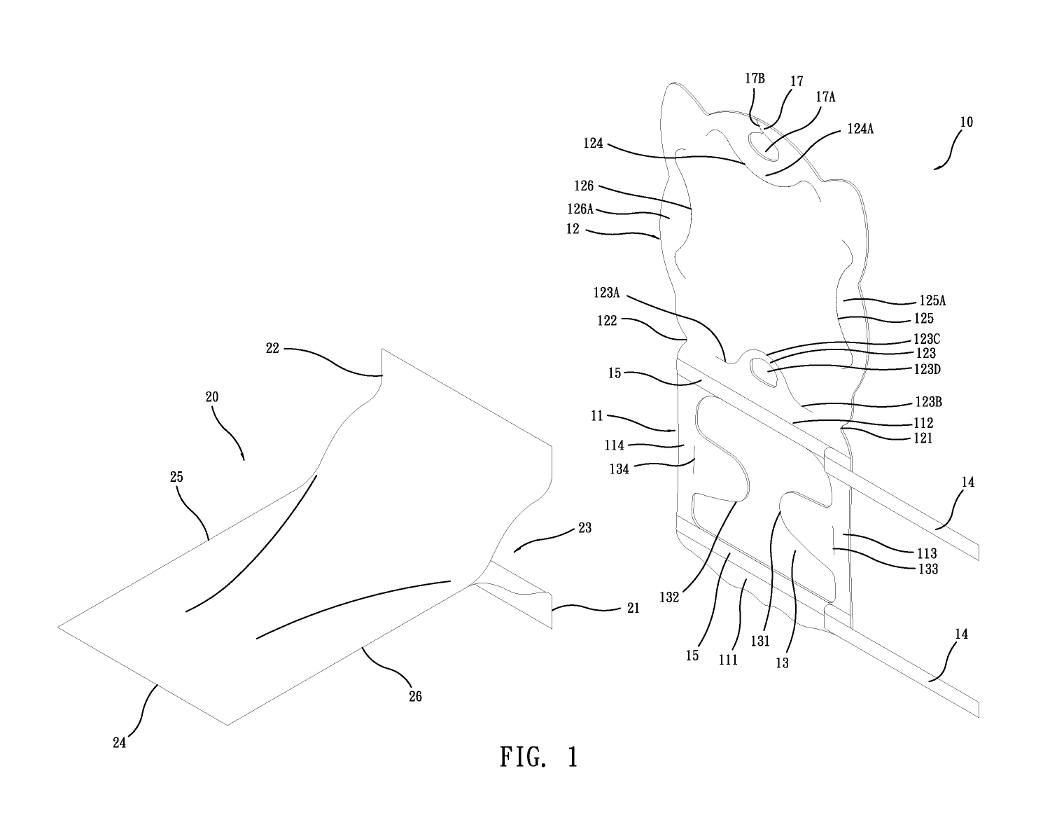

Referring first to FIGS. 1-4, a dog droppings catcher according to a first embodiment of the present invention is shown, comprising a fixing board 10 and a droppings bag 20.

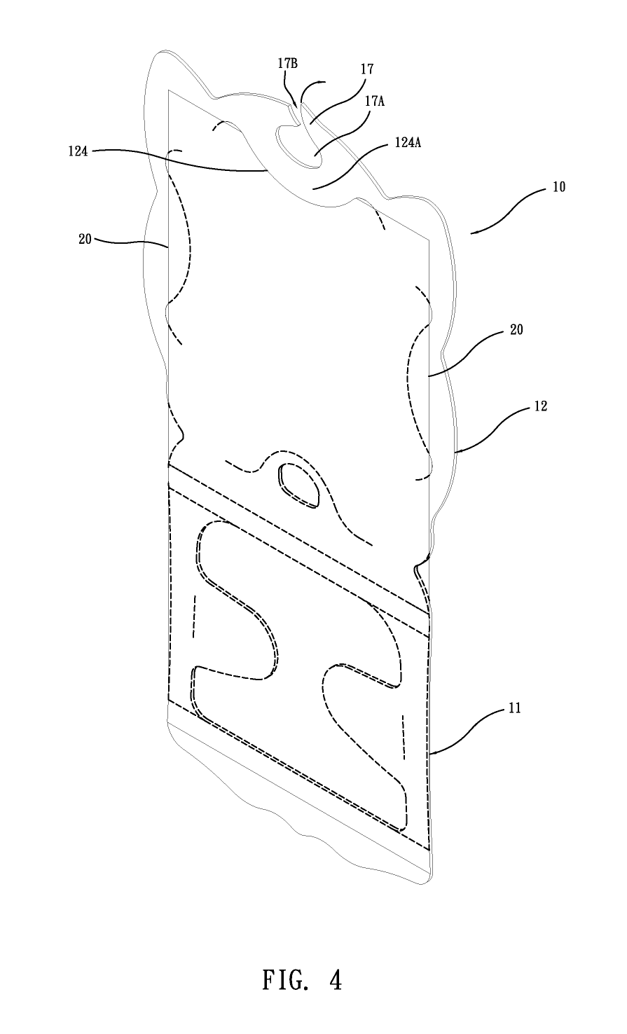

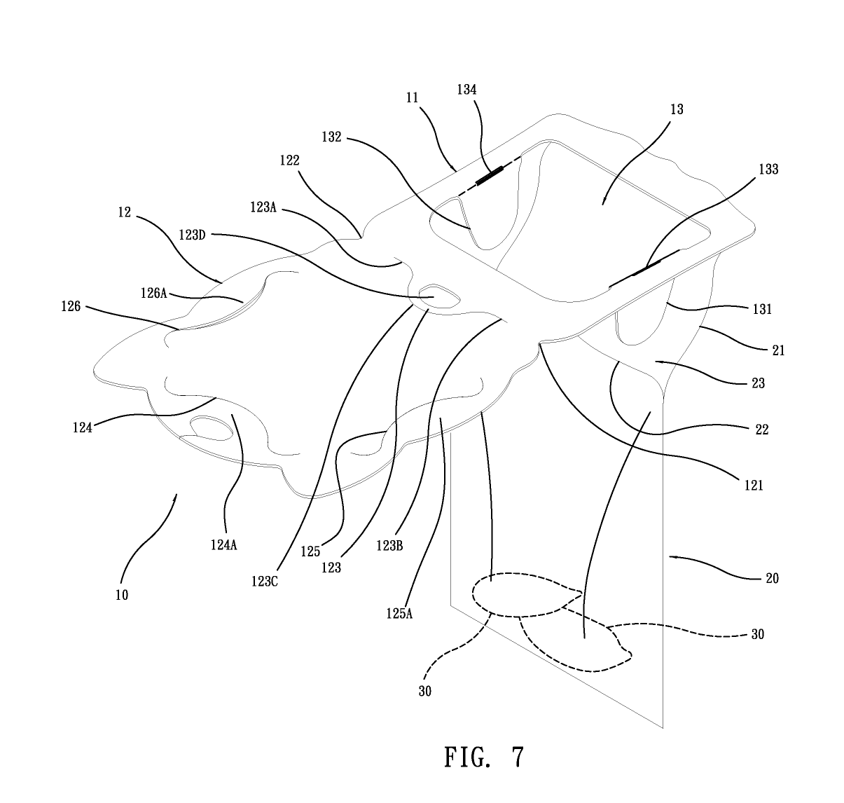

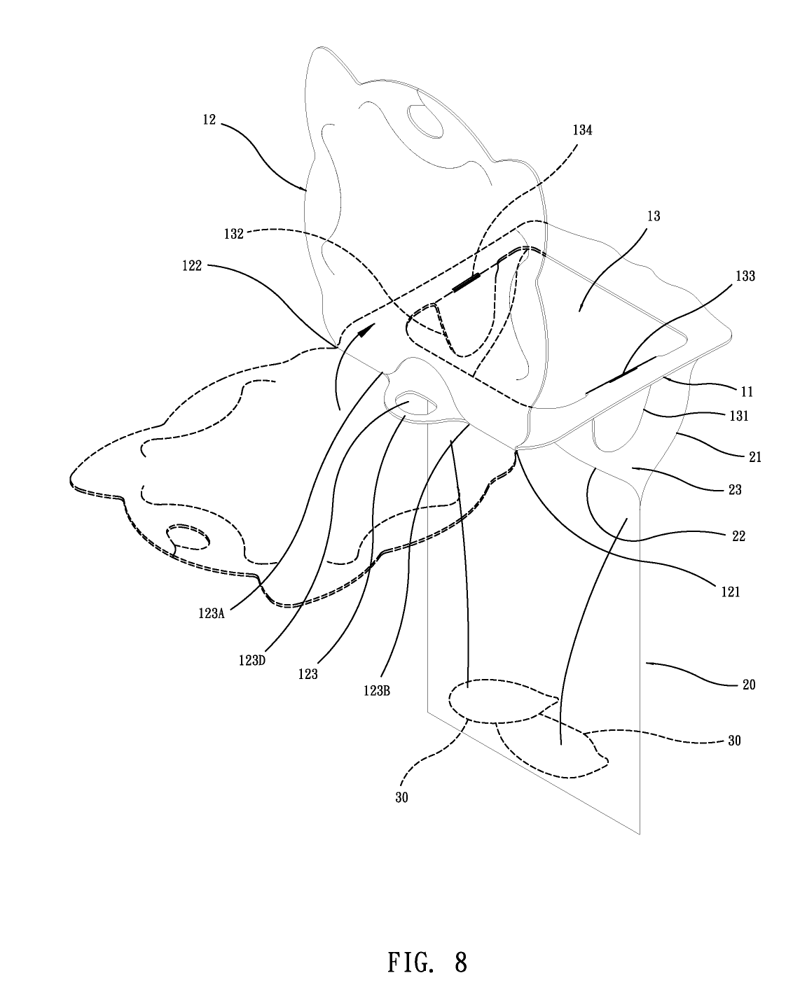

The fixing board 10 is a board having a predetermined strength and is made of for example a paper board, a fiber board, or a bio-decomposable plastic board having an end forming a coupling section 11 and an opposite end forming an opening closure section 12. The coupling section 11 comprises a through hole 13 formed therein. The through hole 13 has two lateral sides respectively forming a first edge 111 and a second edge 112 and two longitudinal sides respectively forming a third edge 113 and a fourth edge 114. The two longitudinal sides of the through hole 13 are each extended inwardly into the hole to form a foldable stop tab 131, 132. Each of the stop tabs 131, 132 has a connection portion connected with the corresponding third edge 113 or fourth edge 114 and comprising a penetrating slit opening 133, 134 formed therein to help effortlessly fold the stop tabs 131, 132. As shown in FIG. 1, a back side of the fixing board 10 is illustrated. The first edge 111 and the second edge 112 are each covered, on the back side thereof, with an adhesive layer 15 and each of the adhesive layers 15 is shielded by a release paper 14. The opening closure section 12 and the coupling section 11 form, in a connection portion therebetween, a folding section. The folding section comprises an inwardly recessed point-tip notch 121, 122 formed in each of two opposite outer contour edges of the fixing board 10 and two penetrating linear slit openings 123A, 123B that are arranged between the two point-tip notches 121, 122 and spaced from each other by a predetermined distance. The arrangement of the two point-tip notches 121, 122 and the two linear slit openings 123A, 123B allows the opening closure section 12 to be easily folded in a direction toward the coupling section 11. In the instant embodiment, the two linear slit openings 123A, 123B are connected to a penetrating curved slit opening 123C arranged therebetween. The curved slit opening 123C is arranged to extend in a direction toward the opening closure section 12 so that the curved slit opening 123C encloses, partly, an area in which a through hole 123D is formed. Referring to FIG. 8, when the opening closure section 12 is folded in a direction toward the coupling section 11, the area that is partly enclosed by the curved slit opening 123C and the through hole 123D collectively constitute a hanging lug 123 that can be hung on an external fixture. Referring to FIG. 7, the opening closure section 12 comprises two side contour portions and an intermediate contour portion each being subjected to cutting to form a penetrating curved slit opening 125, 126, 124. Each of the curved slit openings 125, 126, 124 has two ends sections each arranged to extend in direction toward the interior of the opening closure section 12. Each of the curved slit openings 125, 126, 124 partly encloses an area that constitutes a positioning tab 125A, 126A, 124A that is at least partly foldable upward or downward (as illustrated at 126A of FIG. 7). Based on the physical property of the material used, the positioning tabs 125A, 126A, 124A, when acted upon by an external to be folded and thus deformed, may accumulate a restoration force in the material thereof, provided the force does not exceed a critical point of stress that causes damage, so that the restoration force may help restore the original shape and position or help hold an external object therebetween. In a portion between the curved slit opening 124 and an outer contour of the fixing board 10 corresponding thereto, a through hole 17A is formed and a penetrating and inclined slit opening 17B is formed to extend between the through hole 17A and the outer contour so that the slit opening 17B and the through hole 17A collectively constitute a suspension lug 17. Referring to FIG. 1, two opposite side portions of the slit opening 17B are in tight engagement with each other when no force acts thereon and referring to FIG. 4, the opposite side portions of the slit opening 17B may be deformed to expand the opening when an external force is applied thereto.

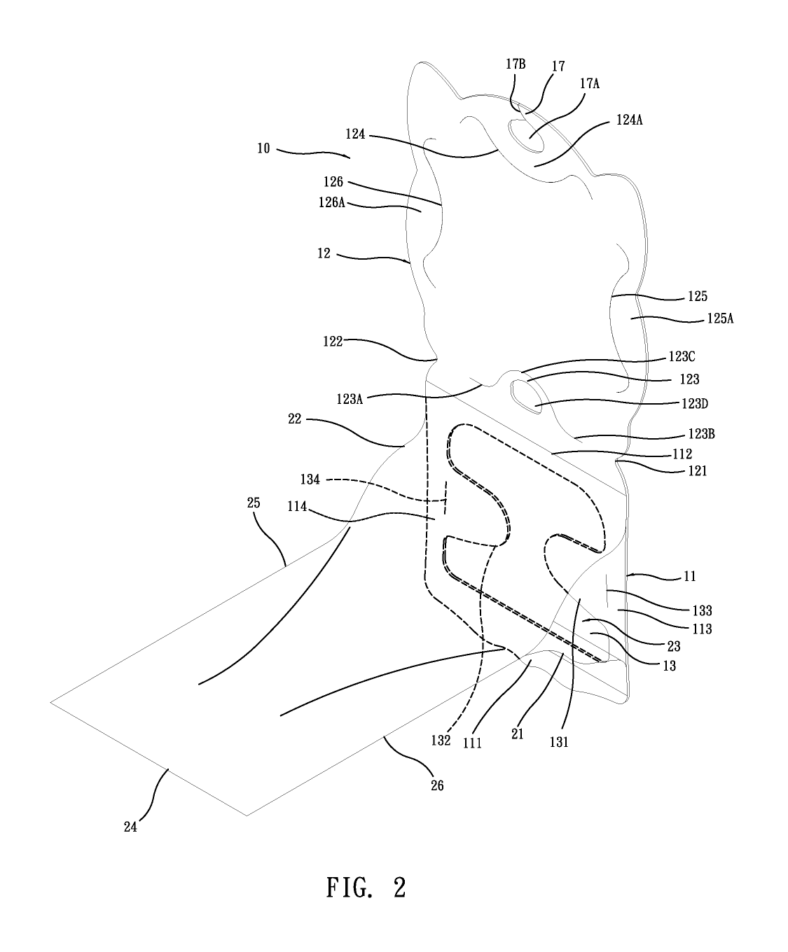

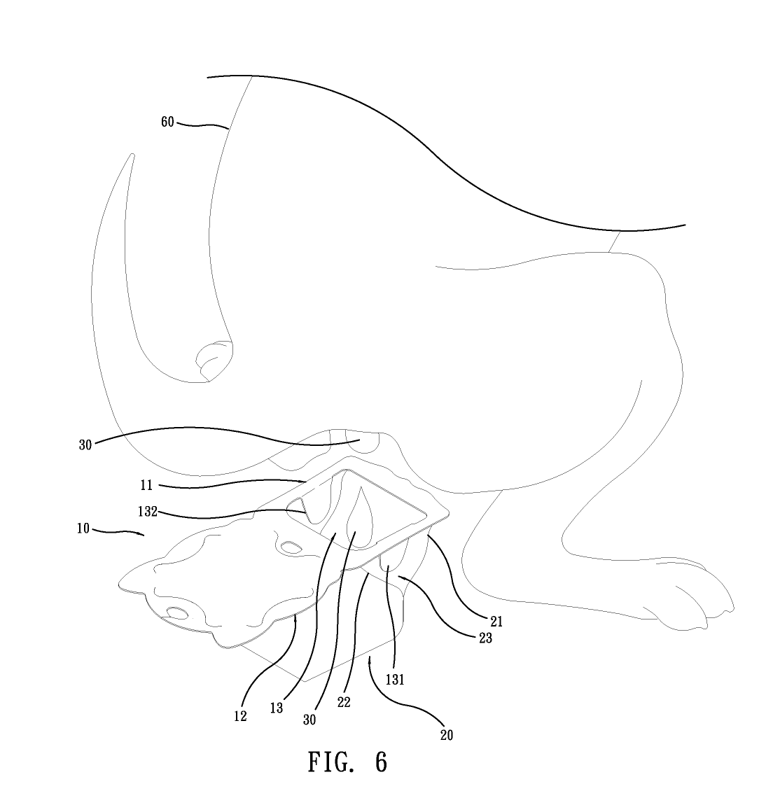

The droppings bag 20 is an elongate bag having an opening 23, which is made of plastic or environment-friendly plastic materials or bio-decomposable plastic materials, or paper or chemical fibrous materials and comprises two lateral edges 25, 26 and a bottom edge 24 that are structured in a completely sealed condition to provide an effect of preventing leakage and also has an interior that defines a receiving space in communication with the opening 23. The opening 23 comprises a first extension section 21 and a second extension section 22 respectively extended from two sides thereof by a predetermined length and separate from each other. The first extension section 21 and the second extension section 22 have upper end edges that are respectively and adhesively attached to the adhesive layer 15 of the back sides or undersides of the first edge 111 and the second edge 112 of the fixing board 10 to combine the droppings bag 20 and the fixing board 10 to each other for receiving and holding dog droppings. The through hole 13 of the coupling section 11 is in communication with the opening 23 of the droppings bag 20 (as shown in FIGS. 2 and 6).

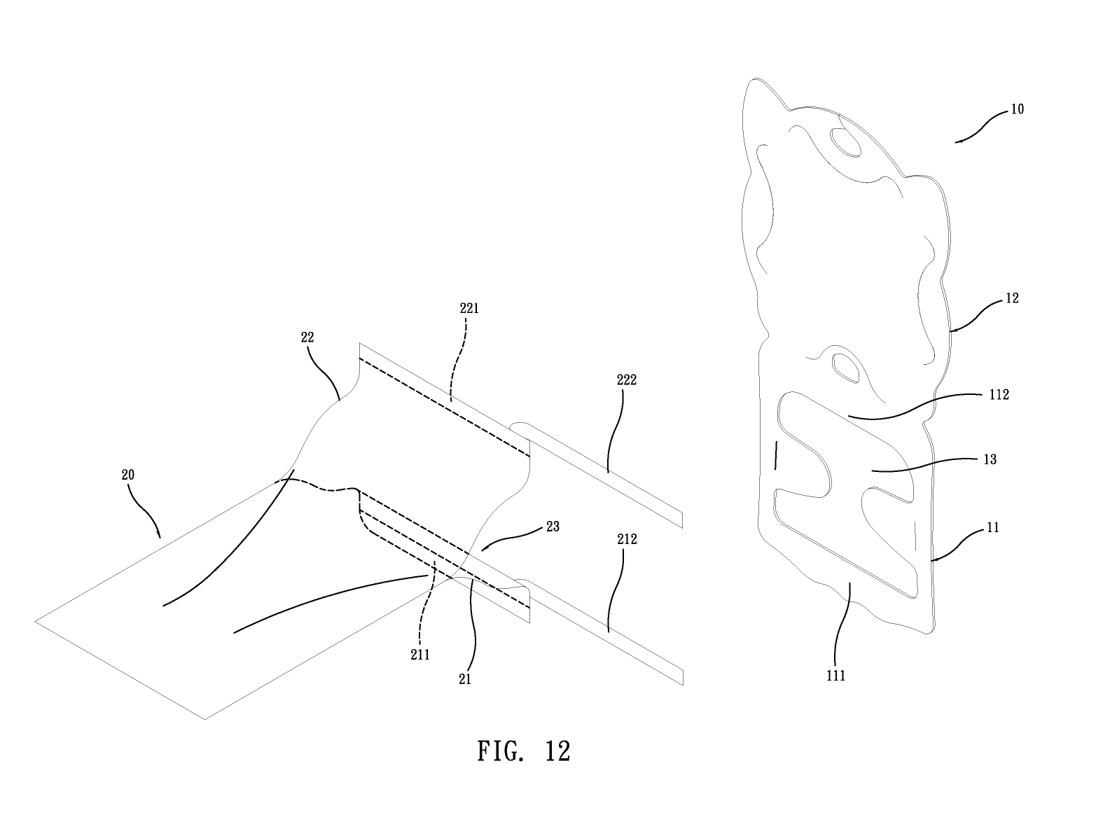

Further, referring to FIG. 12, a second embodiment of the present invention is illustrated, comprising a fixing board 10 and a droppings bag 20, the fixing board 10. The droppings bag 20 is substantially similar, in the structure thereof, to the first embodiment and a difference resides in that the adhesive layers that are applied to the first edge 111 and the second edge 112 of the coupling section 11 in the first embodiment is removed and instead, in the second embodiment, adhesive layers 211, 221 are respectively applied to the upper end edges of the first extension section 21 and the second extension section 22 of the droppings bag 20 with each of the adhesive layers 211, 221 shielded by a release paper 212, 222. Thus, after removal of the release paper 212, 222, the first extension section 21 and the second extension section 22 can be adhesively attached to and fixed to the first edge 111 and the second edge 112 respectively to have the droppings bag 20 and the fixing board 10 combined together to receive and hold dog droppings. In the second embodiment, there is no need to apply adhesive to the first edge 111 and the second edge 112.

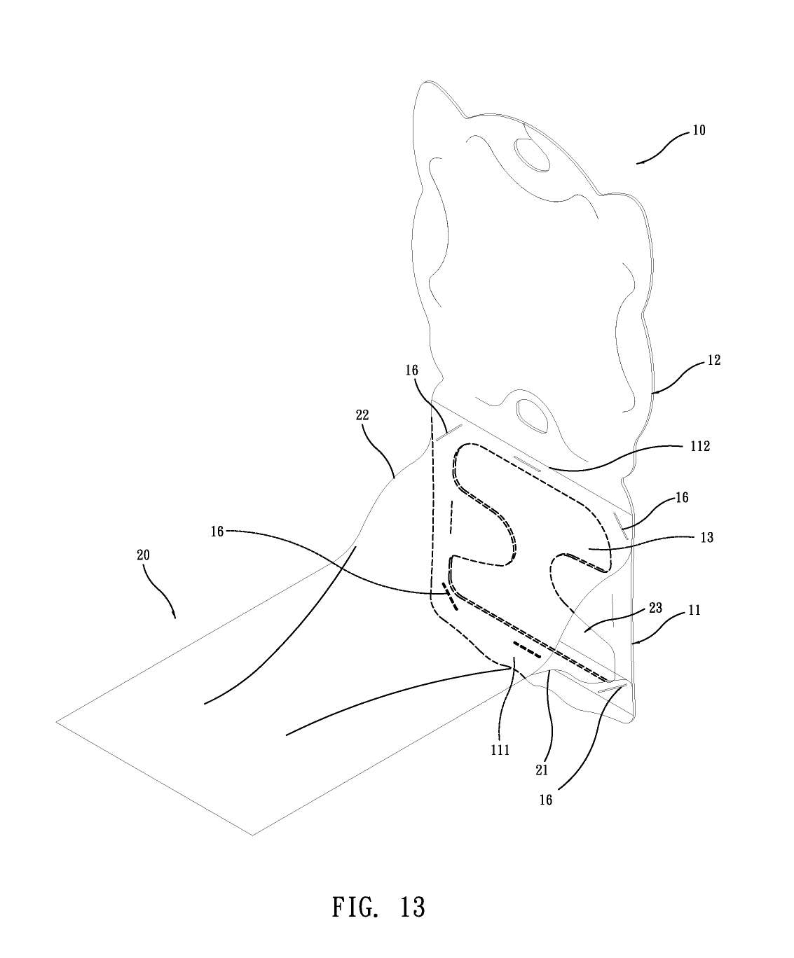

Referring to FIG. 13, a third embodiment of the present invention is illustrated, comprising a fixing board 10 and a droppings bag 20. The fixing board 10 and the droppings bag 20 are similar, in the structures thereof, to counterparts of the first embodiment and a difference resides in that the droppings bag 20 and the fixing board 10 are combined with each other by using staples 16 to joint the upper end edges of the first extension section 21 and the second extension section 22 to the first edge 111 and the second edge 112 respectively. There is no need to apply adhesive to the first edge 111 and the second edge 112 or the first extension section 21 and the second extension section 22. In this way, the droppings bag 20 is combined with the fixing board 10 for being collectively used to receive and hold dog droppings.

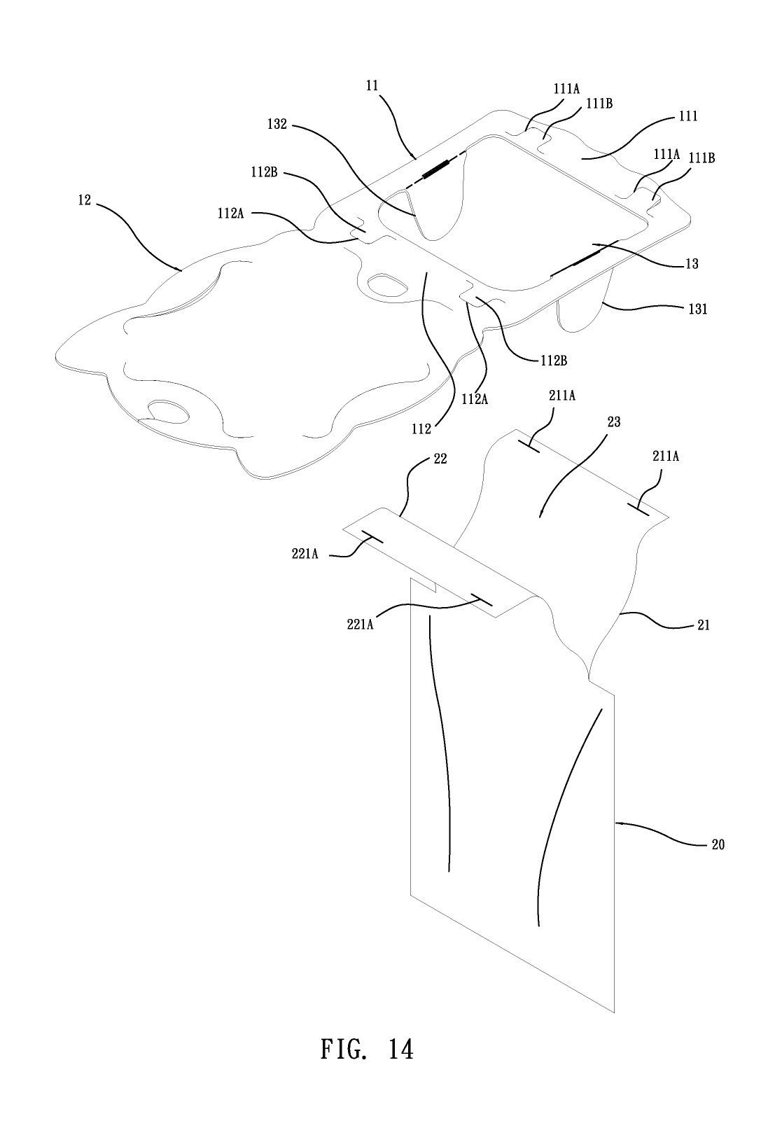

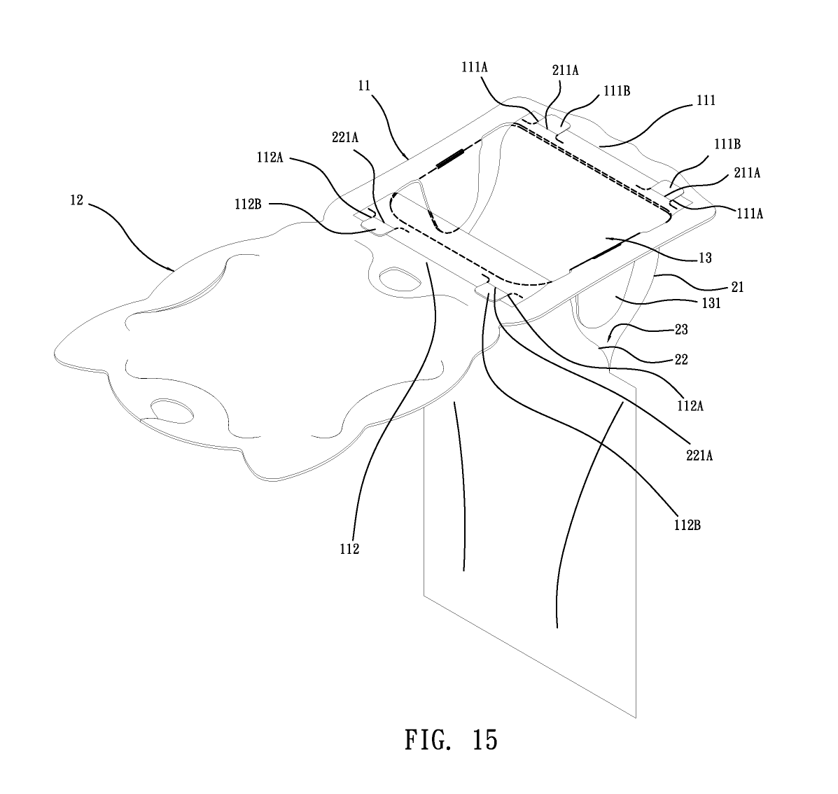

Referring to FIGS. 14 and 15, a fourth embodiment of the present invention is illustrated, comprising a fixing board 10 and a droppings bag 20. The fixing board 10 is similar, in the structure thereof, to that of the first embodiment and a difference resides in that the first edge 111 and the second edge 112 of the coupling section 11 are each provided with a plurality of U-shaped penetrating slit openings 111A, 112A. Each of the slit openings 111A, 112A partly encloses an area that constitutes a positioning tab 111B, 112B that is at least partly foldable upward or downward (as illustrated at 111B of FIG. 14). The plurality of positioning tabs 111B formed in the first edge 111 and the plurality of positioning tabs 112B formed in the second edge 112 are oriented in opposite directions. In the instant embodiment, the droppings bag 20 is similar, in the structure thereof, to that of the first embodiment and a difference resides in that in the instant embodiment, the first extension section 21 and the second extension section 22 of the droppings bag 20 are reduced inward so as to have a reduced width to allow for extension thereof through the through hole 13 of the coupling section 11. The first extension section 21 and the second extension section 22 are each provided a plurality of penetrating slit openings 211A, 221A close to the upper end edges thereof The first extension section 21 is set, from the back side of the coupling section 11, through the through hole 13 to be suspended on bottoms of the positioning tabs 111B of the first edge 111 by having the positioning tabs 111B extend through the slit openings 211A thereof; and the second extension section 22 is set, from the back side of the coupling section 11, through the through hole 13 to be suspended on bottoms of the positioning tabs 112B of the second edge 112 by having the positioning tabs 112B extend through the slit openings 221A thereof. As such, the droppings bag 20 is combined with the fixing board 10 for receiving and holding dog droppings.

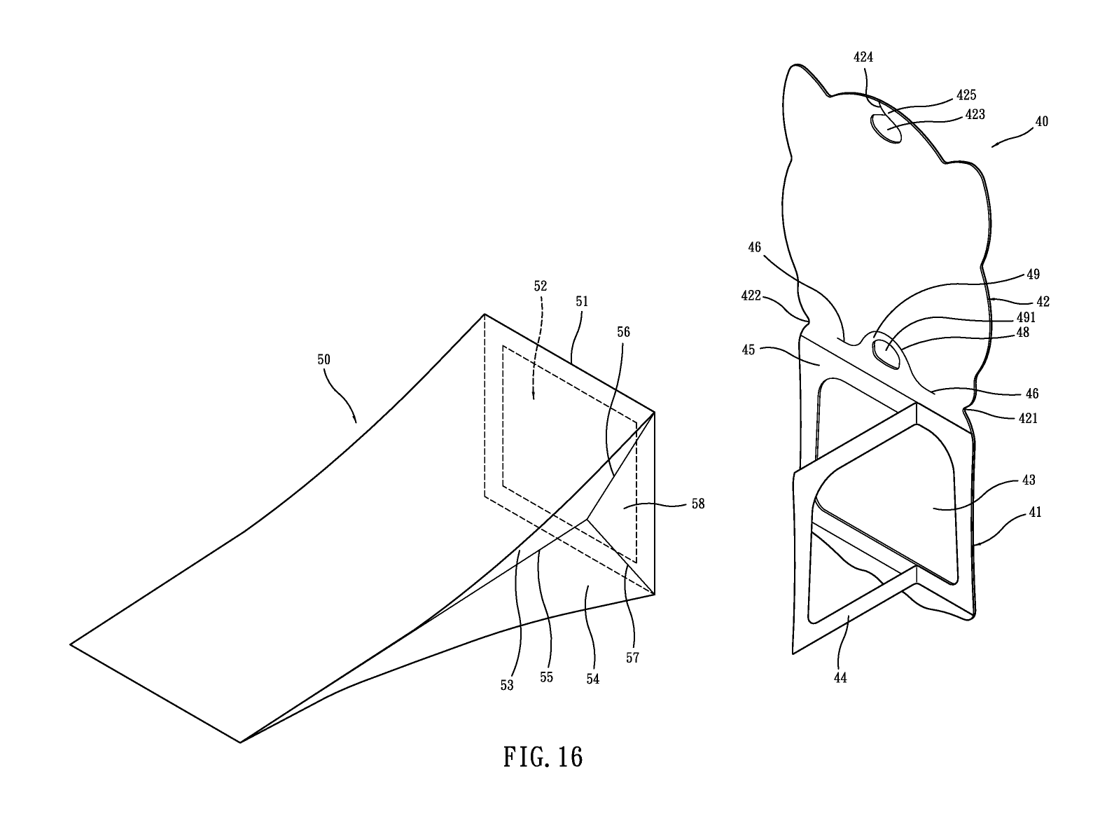

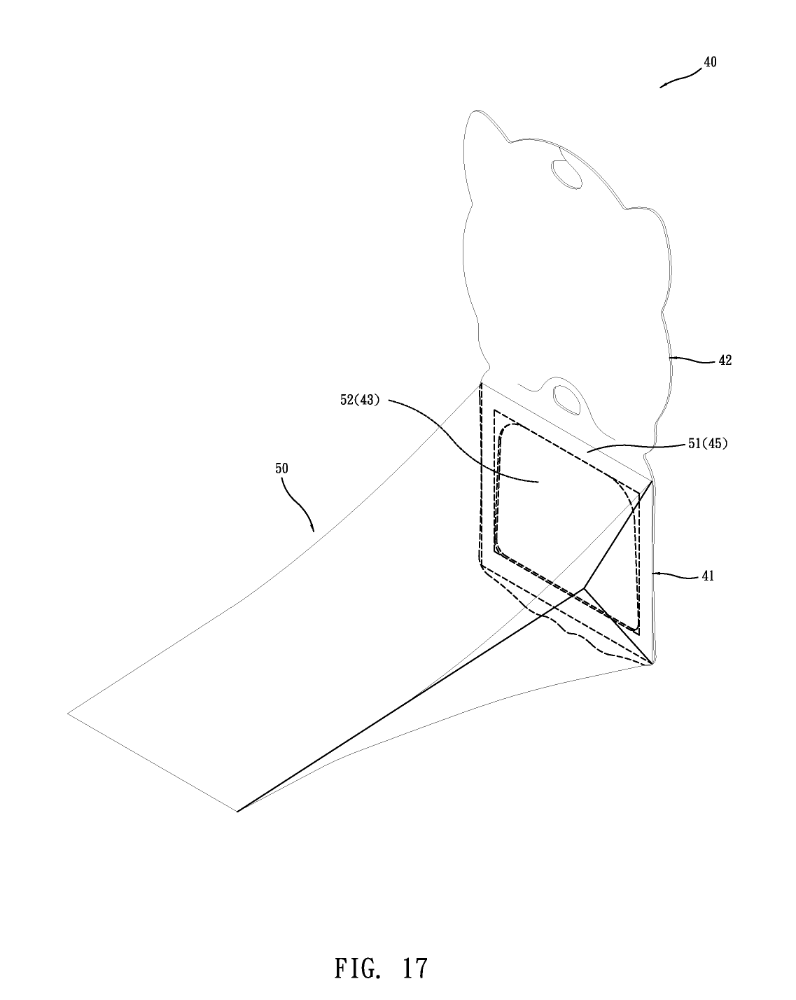

Referring to FIGS. 16-20, a dog droppings catcher constructed in accordance with a fifth embodiment of the present invention is shown, comprising a fixing board 40 and a droppings bag 50.

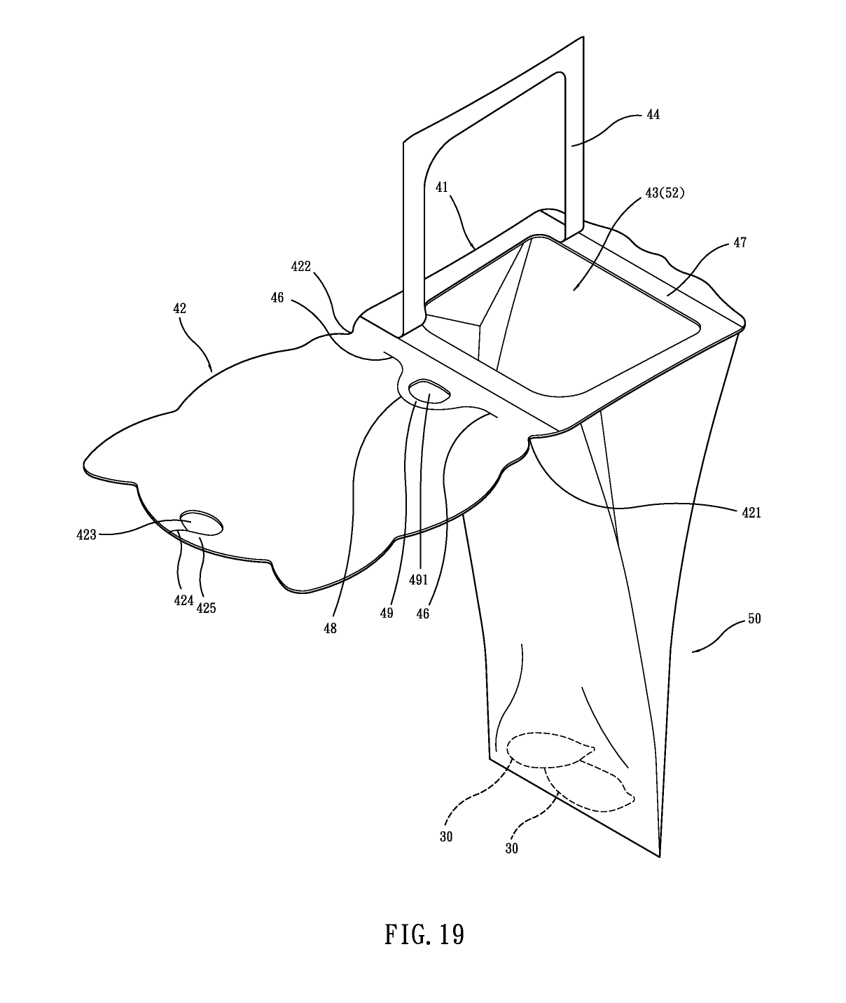

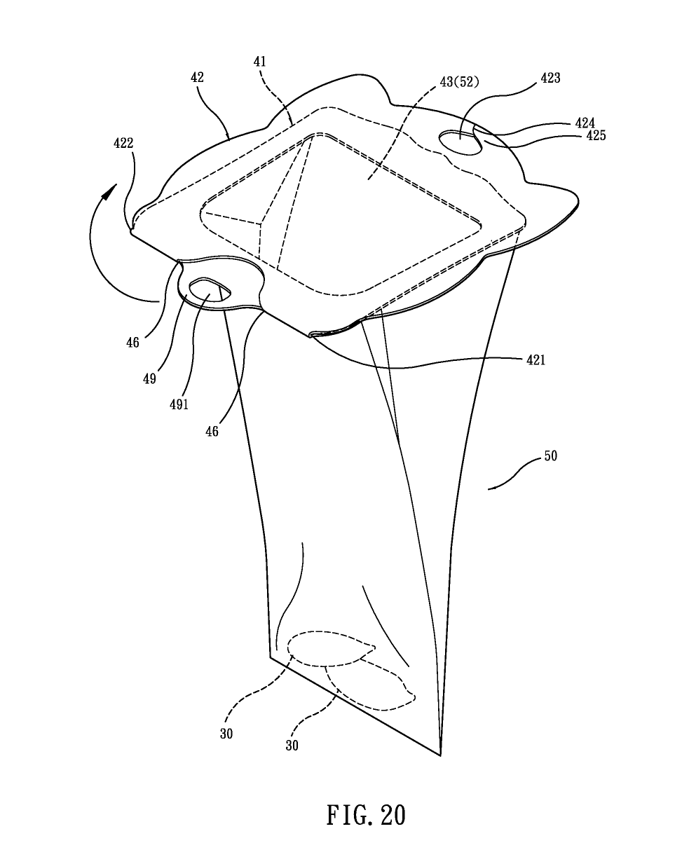

Referring to FIGS. 16 and 19, the fixing board 40 is a board having a predetermined strength and is made of a material including for example a paper board, a fiber board, or a bio-decomposable plastic board having an end forming a coupling section 41 and an opposite end forming an opening closure section 42. The coupling section 41 comprises a through hole 43 formed therein. The coupling section 41 has a back side and a front side both are coated with an adhesive layer 45, 47 arranged alone a circumference of the through hole 43 and shielded by a release paper 44. The opening closure section 42 and the coupling section 41 form, in a connection portion therebetween, a folding section. The folding section comprises an inwardly recessed point-tip notch 421, 422 formed in each of two opposite outer contour edges of the fixing board 40. The fixing board 10 also comprises two penetrating linear slit openings 46 formed therein between the two point-tip notches 421, 422 and spaced from each other by a predetermined distance. The arrangement of the two point-tip notches 421, 422 and the two linear slit openings 46 allows the opening closure section 42 to be easily folded in a direction toward the coupling section 41. In the instant embodiment, the two linear slit openings 46 are connected to a penetrating curved slit opening 48 arranged therebetween. The curved slit opening 48 is arranged to extend in a direction toward the opening closure section 42 so that the curved slit opening 48 encloses, partly, an area in which a through hole 491 is formed. Referring to FIG. 20, when the opening closure section 42 is folded in a direction toward the coupling section 41, the area that is partly enclosed by the curved slit opening 48 and the through hole 491 collectively constitute a hanging lug 49 that can be hung on an external fixture.

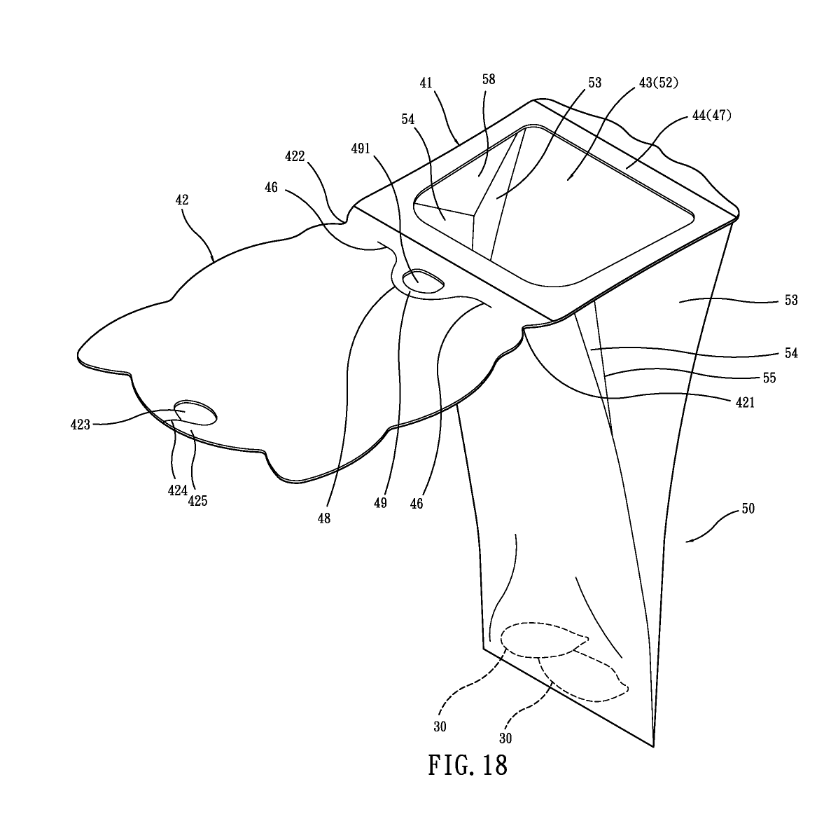

The droppings bag 50 is an elongate bag having an opening 23, which is made of plastic or environment-friendly plastic materials or bio-decomposable plastic materials, or paper or chemical fibrous materials and has a top end that has a top surface 51. The top surface 51 has a central portion in which an opening 52 is formed and also includes, in addition to the opening 52, two lateral sides and a bottom that are structured in a completely sealed condition to provide an effect of preventing leakage and also has an interior that defines a receiving space in communication with the opening 52. The two, left and right, lateral sides of the droppings bag 50 are each inwardly folded to form a first fold edge 53 and a second fold edge 54 with a first fold line 55 defined at a location between the first fold edge 53 and the second fold edge 54. The first fold edge 53, the second fold edge 54, and the first fold line 55 extend from the bottom of the droppings bag 50 toward the top and at a location close to the top surface 51, the first fold line 55 is connected to a second fold line 56 and a third fold line 57 that define a V-shaped configuration. The second fold line 56 and the third fold line 57 extend to an edge of the top surface 51 to define a third fold edge 58 therebetween. The third fold edge 58, the first fold edge 53, and the second fold edge 54 of each of the two lateral sides of the droppings bag 50 are completely foldable to be concealed between two surfaces of the droppings bag 50 to make the droppings bag 50 flat in configuration. The third fold edges 58, the first fold edges 53, and the second fold edges 54 of the two lateral sides, when squeezed, are expanded outward to thereby expand the interior receiving space of the droppings bag 50. The top surface 51 of the droppings bag 50 is adhesively attachable to the adhesive layer 45 on the circumference of the through hole 43 and on the back side of the fixing board 40 so as to combine the droppings bag 50 and the fixing board 40 together with the opening 52 of the droppings bag in communication with the through hole 43 of the coupling section 41. The droppings bag 50 and the fixing board 40 so combined together can be used to receive and hold dog droppings. Referring to FIGS. 18-20, after dog droppings 30 have been received and held in the bag, the release paper 46 on the front side of the coupling section 41 is removed to expose the adhesive layer 47 (see FIG. 19). The opening closure section 42 is then folded toward the coupling section 41 and thus laid flat on the coupling section 41. The opening closure section 42 has a surface area greater than the through hole 43 of the coupling section 41 so that the opening closure section 42 may completely covers the through hole 43 and the adhesive layer 47 securely and adhesively fix the opening closure section 42 to prevent the opening closure section 42 from being opened again. In this way, odor smell spread from dog droppings 30 held in the droppings bag 50 can be reduced.

The present invention, as illustrated in the above discussed first to fifth embodiment, is generally of a structure that allows for DIY by a pet owner. However, combination of the droppings bag 20, 50 and the fixing board 10, 40 can be achieved with high frequency or ultrasonic welding or thermal pressing to have the droppings bag 20 and the fixing board 10 (or the droppings bag 50 and the fixing board 40) combined together before sales.

The operation and effectiveness of the dog droppings catcher according to the present invention will be described with reference to the first embodiment and associated drawings.

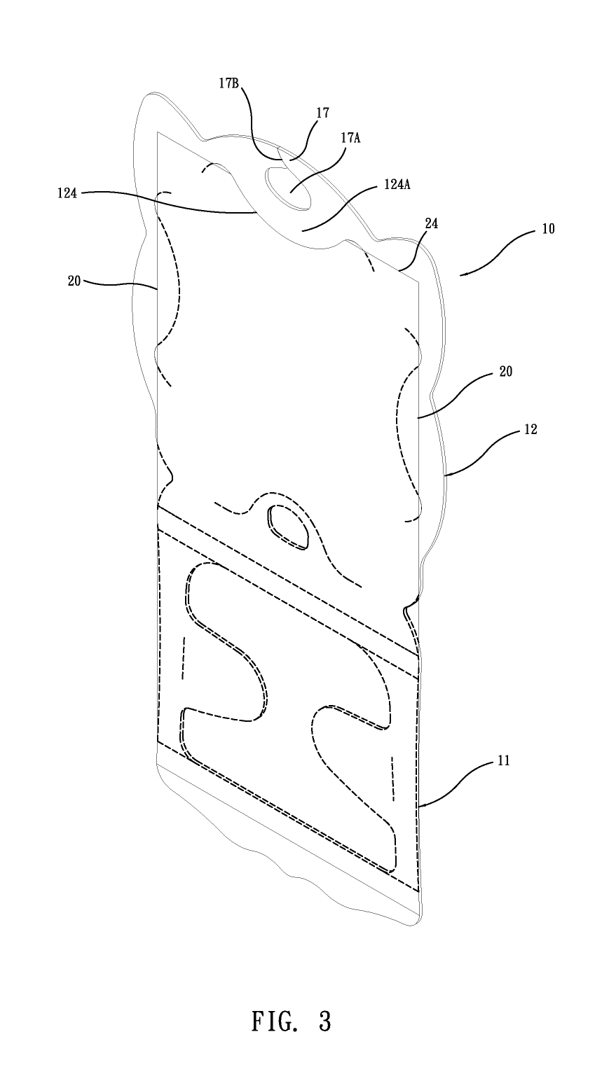

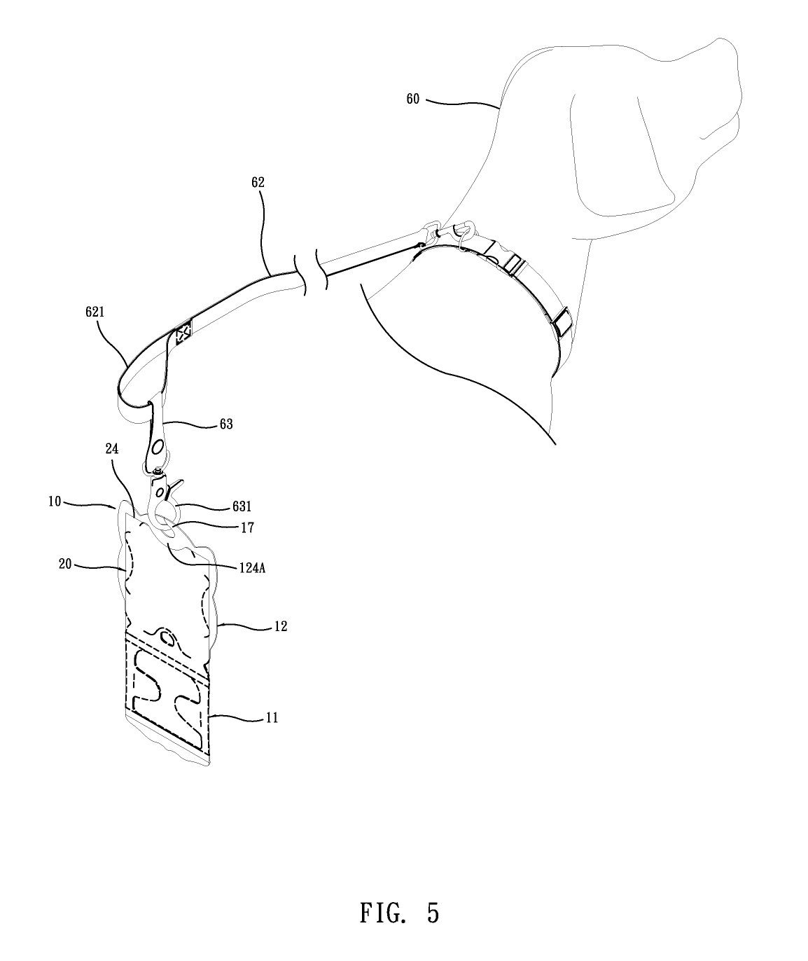

Referring to FIGS. 3-11, the present invention, which offers a compact and light-weight design, allows for easy carrying by an owner, for example by being held in a hand or inserted into a clothing pocket or a bag. Alternatively, when a dog owner walks his or her dog outside, the device can be attached to a ring 63 formed on a hand grip section 621 of a leash 62 by means of the suspension lug 17 of the fixing board 20. The ring 63 may comprises an openable/closable hook 631 to allow the suspension lug 17 of the fixing board 20 to be suspended on the hook 631 with the bottom edge 24 of the droppings bag 20 clamped and held in position by the positioning tabs 124A without randomly swaying (see FIGS. 3 and 5) and can be easily accessed when a dog 60 is going to discharge droppings. For example, in case of being suspended on the hook 631, the dog owner may use one hand to hold the hand grip section 621 of the leash 62, while the other hand is empty and free so that the free hand can grip and pull the fixing board 10 downward, whereby the slit opening 17B is forcibly expanded to allow the fixing board 10 to be removed. The bottom edge 24 of the droppings bag 20 may then detach from the positioning tab 124A and depends naturally. A force is then applied to the two stop tabs 131, 132 for folding downward to completely open the through hole 13 so that before dog droppings 30 discharged from the dog 60 fall onto the ground, the owner may grip and hold an end of the opening closure section 12 to place the coupling section 11 close to the hips of the dog 60 and, when dog droppings 30 appears on the anus of the dog, to align the through hole 13 of the coupling section 11 with the dog droppings 30 so as to allow dog droppings 30 to fall down and pass through the through hole 13 and the opening 23 of the droppings bag 20 to get into the droppings bag 20. The arrangement of the two stop tabs 131, 132 help constrain and prevent the dog droppings 30 from falling out between the first extension section 21 and the second extension section 22 of the droppings bag 20. The dog droppings 30 to be received into the droppings bag 20 are caused by the gravity thereof to slide down into the bottom of the droppings bag 20, whereby the droppings bag 20 slightly bulges out and deforms due to the dog droppings 30 (as shown in FIG. 7). The opening may then be closed when the dog no long discharges droppings.

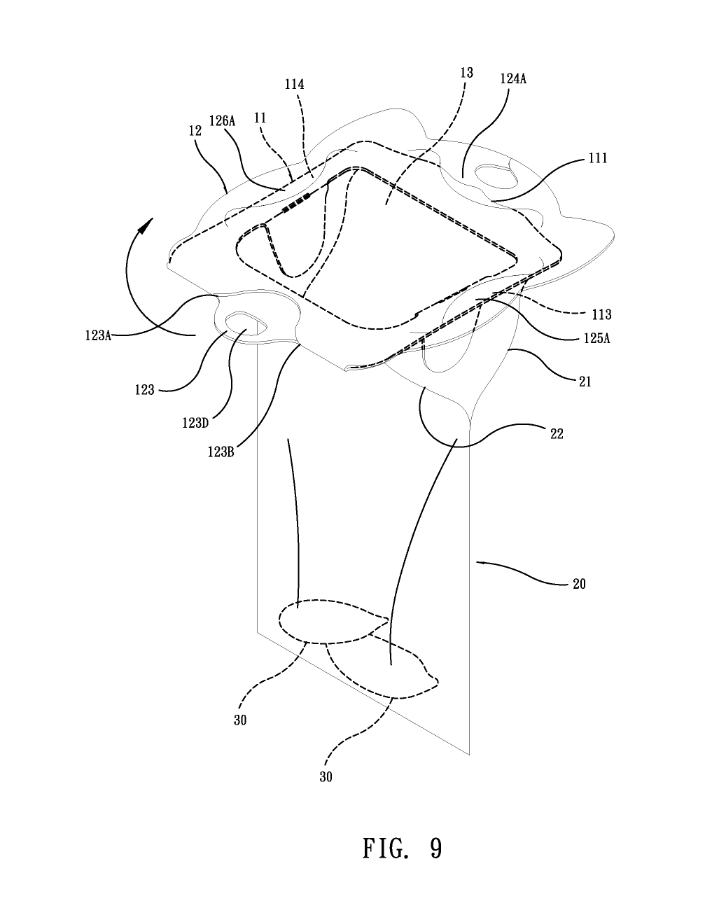

Referring to FIGS. 7-10, the droppings bag 20 with dog droppings 30 received and held therein, if being directly disposed into a garbage bin, would cause odor smell of dog droppings spreading over a large span of area. Thus, the gap between the through hole 13 and the first extension section 21 and the second extension section 22 must be properly sealed to reduce the spreading of odor smell of dog droppings. Firstly, the opening closure section 12 is folded toward the coupling section 11. With the arrangement that the two point-tip notches 121, 122 and the two linear slit openings 123A, 123B are generally located on a straight line, the opening closure section 12 can be folded, in an effortless manner, toward the coupling section 11. Due to the arrangement of the curved slit opening 123C, the hanging lug 123 would become located on a contour edge, allowing for easy suspension. Since the opening closure section 12 has a surface area that is greater than the through hole 13 of the coupling section 11, the opening closure section 12, when flat laid on the coupling section 11, would completely cover and close the through hole 13 (as shown in FIG. 9). A force is then applied to the positioning tab 124A to make it move downward to pass over the first edge 111 of the coupling section 11 so that due to a reaction force induced, the positioning tab 124A may clamp and securely hold the first edge 111 in position to keep the opening closure section 12 and the coupling section 11 in a flat laid condition. Afterwards, the fixing board 10 so folded is turned to have the hanging lug 123 located on the upper side, while the droppings bag 20 is located in front of the dog owner (namely on the front side of the fixing board 10 so folded).

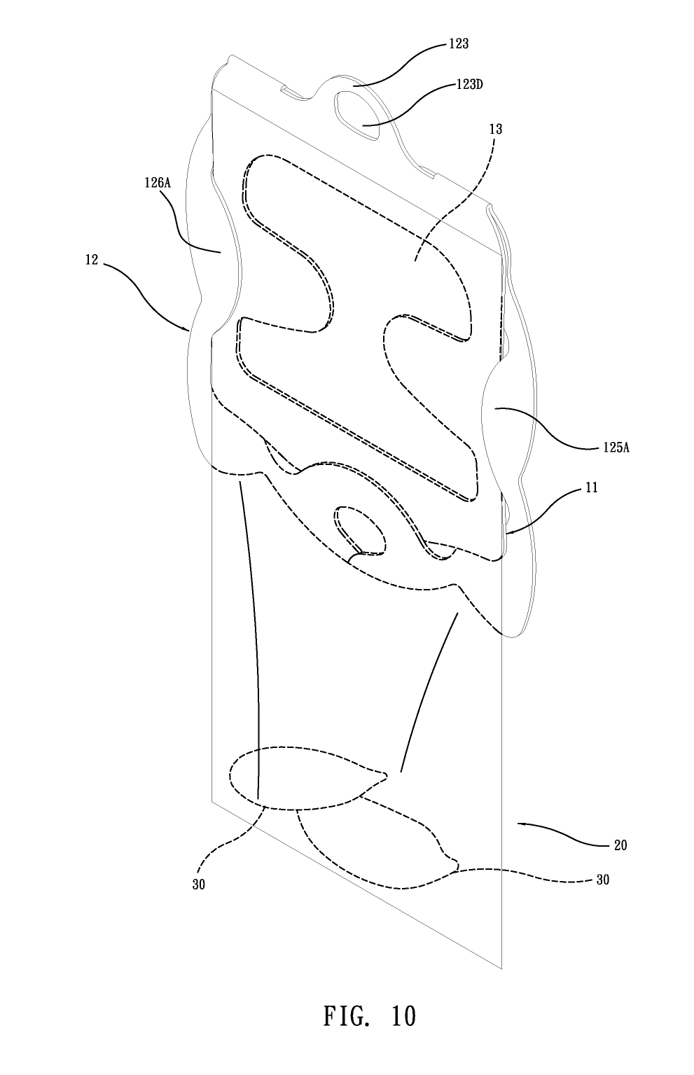

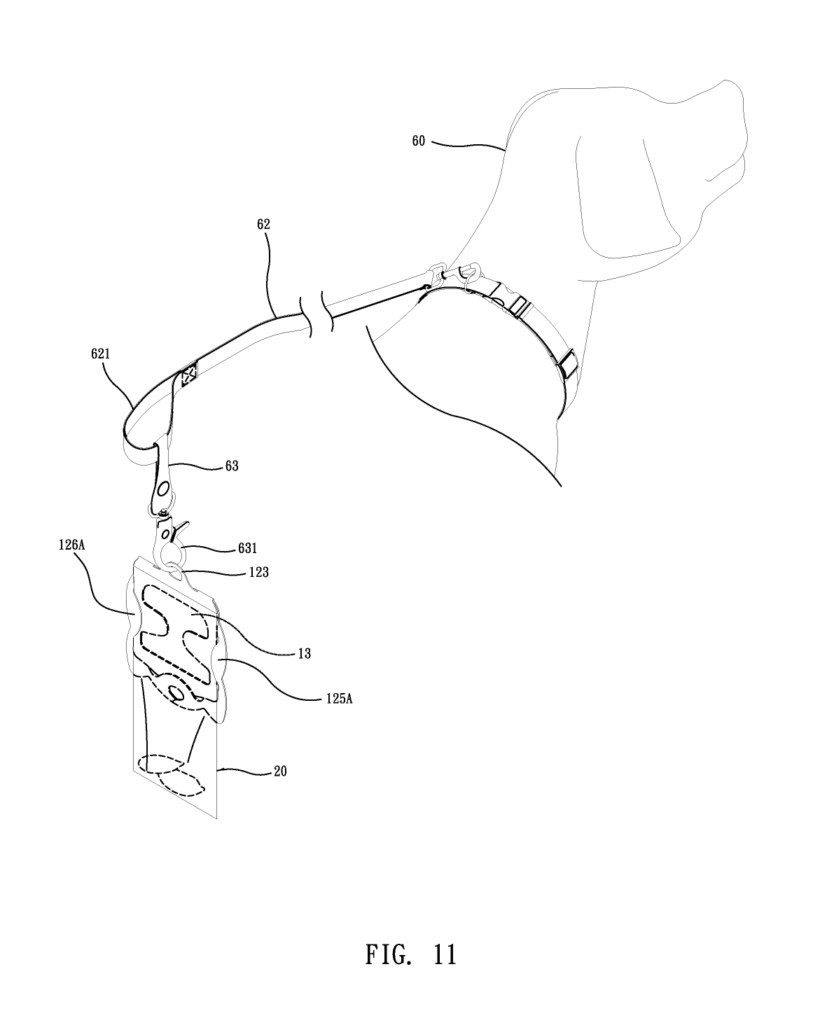

The droppings bag 20 is dragged downward by the gravity of the dog droppings 30 to have the droppings bag 20 abut the coupling section 11 (as shown in FIG. 10). Then, forces are applied to the positioning tabs 125A, 126A to have them move forward to pass over the third edge 113 and the fourth edge 114 of the coupling section 11, whereby due to reaction forces induced, the positioning tabs 125A, 126A clamp and hold the third edge 113 and the fourth edge 114 in position and also clamp two sides of the droppings bag 20 (approximately corresponding to the overlapping site between the first extension section 21 and the second extension section 22) that abut the coupling section 11 to reduce the odor smell of the dog droppings 30 received in the droppings bag 20 spreading through the gap between the through hole 13 and the first extension section 21 and the second extension section 22. As such, the bag may then be disposed into a garbage bin. In this way, handling and cleaning of dog droppings is easy and convenient without causing staining and contamination of the ground by dog droppings. Referring to FIG. 11, if no garbage bin is available is the field where the dog owner walks the dog, temporary suspension can be achieved by having the hanging lug 123 hung on the hook 631 of the ring 63, whereby the dog owner only uses one hand to hold the dog, while the other hand is free to do other things. The operations and effectiveness obtained from the second to fifth embodiments are similar to what discussed above so that no repeated description will be necessary herein.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A dog droppings catcher, comprising a fixing board and a droppings bag, the fixing board having an end forming a coupling section and an opposite end forming an opening closure section, the droppings bag comprising an opening and an interior that defines a receiving space in communication with the opening, the droppings bag being combinable with the coupling section, the coupling section comprising a through hole in communication with the opening of the droppings bag.

2. The dog droppings catcher according to claim 1, wherein the fixing board comprises a suspension lug, the suspension lug being arranged at an outer contour portion of the fixing board, the suspension lug comprising a through hole and a penetrating slit opening extending from an edge of the through hole to an outer contour.

3. The dog droppings catcher according to claim 1, wherein the coupling section and the opening closure section form therebetween a folding section to allow the opening closure section to be folded, in an effortless manner, toward and laid flat on the coupling section.

4. The dog droppings catcher according to claim 3, wherein the fixing board comprises an inwardly recessed point-tip notch formed in each of two opposite outer contour edges thereof so that the folding section is formed between the two point-tip notches with the coupling section arranged at one end of the folding section and the opening closure section at an opposite end.

5. The dog droppings catcher according to claim 4, wherein the fixing board comprises a hanging lug formed between the two point-tip notches, the hanging lug being formed by a curved slit opening and a through hole formed in an area that is partly enclosed by the curved slit opening, the curved slit opening being arranged to extend toward the opening closure section.

6. The dog droppings catcher according to claim 4, wherein the fixing board comprises at least one penetrating linear slit opening arranged between the two point-tip notches.

7. The dog droppings catcher according to claim 1, wherein the opening closure section comprises two side contour portions and an intermediate contour portion each being subjected to cutting to form a penetrating curved slit opening, each of the slit openings partly enclosing an area that constitutes a positioning tab that is at least partly foldable upward or downward.

8. The dog droppings catcher according to claim 1, wherein the through hole of the coupling section has two opposite sides each forming a stop tab extending inwardly into the hole, each of the stop tabs having a connection portion connected with an edge of the hole and subjected to cutting to form a penetrating slit opening, the stop tabs being foldable.

9. The dog droppings catcher according to claim 1, wherein the coupling section has a back side on which an adhesive layer is coated completely or partly around a circumference of the through hole, the adhesive layer being shielded by a release paper.

10. The dog droppings catcher according to claim 1, wherein the coupling section has a front side and a back side that are each coated with an adhesive layer completely or partly around a circumference of the through hole, the adhesive layers being each shielded by a release paper.

11. The dog droppings catcher according to claim 1, wherein the droppings bag is an elongate bag having a two lateral sides and a bottom that completely sealed to provide an effect of preventing leakage and a top comprising an opening formed therein, the opening comprising a first extension section and a second extension section respectively extended from two sides thereof by a predetermined length, the first extension section and the second extension section being attachable to the coupling section with the through hole of the coupling section in communication with the opening of the droppings bag.

12. The dog droppings catcher according to claim 1, wherein the droppings bag has a top end that has a top surface with an opening being formed in a central portion of the top surface and also has, in addition to the opening two lateral sides and a bottom that are completely sealed to provide an effect of preventing leakage, the two lateral sides being each inwardly folded, between two surfaces of the bag, to form a first fold edge and a second fold edge that are overlappable on each other, a first fold line being defined between the first fold edge and the second fold edge, the first fold edge, the second fold edge, and the first fold line extending from the bottom toward the top, the first fold line being connected to a second fold line and a third fold line that define a V-shaped configuration at a location close to the top surface, the second fold line and the third fold line defining a third fold edge with an edge of the top surface, the third fold edge, the first fold edge, and the second fold edge being completely concealable between the two surfaces of the droppings bag to make the droppings bag flat in configuration, the top surface of the droppings bag being attachable to the coupling section with the through holes of the coupling section in communication with the opening of the droppings bag.

13. The dog droppings catcher according to claim 1, wherein the droppings bag and the fixing board are combined together by means of high frequency or ultrasonic welding or thermal pressing.

14. The dog droppings catcher according to claim 1, wherein the droppings bag and the fixing board are combined together by means of staples.

15. The dog droppings catcher according to claim 11, wherein the first extension section and the second extension section the droppings bag have upper edges on each of which an adhesive layer is coated, the adhesive layer being shielded by a release paper.
